(19) United States
(12) Patent Application Publication
(10) Pub. No.: US 2018/0292821 A1
(43) Pub. Date: Oct. 11, 2018

(54) VEHICLE CONTROL SYSTEM, VEHICLE CONTROL METHOD, AND STORAGE MEDIUM

(71) Applicant: HONDA MOTOR CO., LTD., Tokyo (JP)

(72) Inventors: Muneatsu Minato, Wako-shi (JP); Hajime Ishihara, Wako-shi (JP); Manabu Matsumoto, Wako-shi (JP); Kenta Hirayama, Wako-shi (JP); Yosuke Nishimura, Wako-shi (JP)

(21) Appl. No.: 15/943,896

(22) Filed: Apr. 3, 2018

(30) Foreign Application Priority Data
Apr. 7, 2017 (JP) 2017-076860

(51) Int. Cl. G05D 1/00; B60N 2/02; B60N 2/00

(52) U.S. Cl. CPC G05D 1/0061; B60N 2002/0212; B60N 2/002; B60N 2/0244

(57) ABSTRACT

A vehicle control system includes: a seat (310) in which an occupant sits; a first slide mechanism (320) configured to enable movement of the seat in a longitudinal direction of a vehicle; a second slide mechanism (322) configured to enable movement of the seat in the longitudinal direction of the vehicle and to be movable in the longitudinal direction of the vehicle along the first slide mechanism; an automated driving control unit configured to execute automated driving of automatically controlling at least one of acceleration/deceleration and steering of the vehicle; and a seat control unit configured to enable movement of the seat using the first slide mechanism and the second slide mechanism in a case that the automated driving is being executed by the automated driving control unit and to enable movement of the seat using the first slide mechanism in a case that the automated driving is not being executed.

### CROSS-REFERENCE TO RELATED APPLICATION

Priority is claimed on Japanese Patent Application No. 2017-076860, filed Apr. 7, 2017, the content of which is incorporated herein by reference.

### BACKGROUND OF THE INVENTION

### Field of the Invention

The invention relates to a vehicle control system, a vehicle control method, and a storage medium.

### Description of Related Art

In the related art, a slide device for a vehicle seat that can cause at least one of a front seat and a rear seat which are adjacent to each other in a longitudinal direction to the vicinity of the other seat is known (for example, see Japanese Unexamined Patent Application, First Publication No. 2003-127722).

### SUMMARY OF THE INVENTION

However, in the technique according to the related art, sliding of a seat may not be appropriately controlled depending on control modes of a vehicle.

The invention is made in consideration of the above-mentioned circumstances and an object thereof is to provide a vehicle control system, a vehicle control method, and a storage medium that can realize movement of a seat in a longitudinal direction of a vehicle depending on control modes of the vehicle.

A vehicle system, a vehicle control method, and a storage medium according to the invention employ the following configurations.

(1) According to an aspect of the invention, there is provided a vehicle control system including: a seat in which an occupant sits; a first slide mechanism configured to enable movement of the seat in a longitudinal direction of a vehicle; a second slide mechanism configured to enable movement of the seat in the longitudinal direction of the vehicle and to be movable in the longitudinal direction of the vehicle along the first slide mechanism; an automated driving control unit configured to execute automated driving of automatically controlling at least one of acceleration/deceleration and steering of the vehicle; and a seat control unit configured to enable movement of the seat using the first slide mechanism and the second slide mechanism in a case that the automated driving is being executed by the automated driving control unit and to enable movement of the seat using the first slide mechanism in a case that the automated driving is not being executed.

(2) In the aspect of (1), the automated driving control unit switches the automated driving to manual driving subject to return of the second slide mechanism to a slide position before the automated driving is executed.

(3) In the aspect of (1), the second slide mechanism includes a mechanism that stepwise moves the seat in a case that the seat is moved rearward.

(4) In the aspect of (3), the second slide mechanism further includes a restraint unit that restrains movement of the seat at predetermined distances in a case that the seat is moved rearward.

(5) In the aspect of (1), the second slide mechanism includes an urging unit that applies a forward urging force to the seat.

(6) In the aspect of (1), the vehicle control system further includes an occupant determining unit configured to determine whether an occupant sits in a rear seat of the seat, and the seat control unit prohibits movement of the seat using the second slide mechanism in a case that the occupant determining unit determines that an occupant sits in the rear seat.

(7) According to another aspect of the invention, there is provided a vehicle control method including causing an on-board computer: to execute automated driving of automatically controlling at least one of acceleration/deceleration and steering of a vehicle; to enable movement of a seat in which an occupant sits using a first slide mechanism that enables movement of the seat in a longitudinal direction of the vehicle and a second slide mechanism that enables movement of the seat in the longitudinal direction of the vehicle and that is movable in the longitudinal direction of the vehicle along the first slide mechanism in a case that the automated driving is being executed; and to enable movement of the seat using the first slide mechanism in a case that the automated driving is not being executed.

(8) According to another aspect of the invention, there is provided a storage medium having a vehicle control program stored therein, the vehicle control program causing an on-board computer: to execute automated driving of automatically controlling at least one of acceleration/deceleration and steering of a vehicle; to enable movement of a seat in which an occupant sits using a first slide mechanism that enables movement of the seat in a longitudinal direction of the vehicle and a second slide mechanism that enables movement of the seat in the longitudinal direction of the vehicle and that is movable in the longitudinal direction of the vehicle along the first slide mechanism in a case that the automated driving is being executed; and to enable movement of the seat using the first slide mechanism in a case that the automated driving is not being executed.

According to the aspect of any one of (1), (7), and (8), it is possible to realize movement of a seat in a longitudinal direction of a vehicle depending on control modes of the vehicle.

According to the aspect of (2), it is possible to determine whether the second slide mechanism has returned to the position at which the occupant executes the manual driving on the basis of the position information of the second slide mechanism According to the aspect of any one of (3) to (5), it is possible to rapidly return the seat to the position at which the occupant executes the manual driving.

According to the aspect of (6), it is possible to prevent a seat from coming in contact with an occupant sitting in a rear seat.

### BRIEF DESCRIPTION OF THE DRAWINGS

FIG. 1 is a diagram showing a configuration of a vehicle system according to an embodiment;

FIG. 2 is a diagram showing a state in which a position and a posture of a vehicle relative to a traveling lane are recognized by a vehicle position recognizing unit;

FIG. 3 is a diagram showing a state in which a target path is generated on the basis of a recommended lane;

FIG. 4 is a diagram showing a configuration of a seat device according to the embodiment;

FIG. 5 is a diagram showing a sectional structure of a first slide mechanism and a second slide mechanism;

FIG. 6 is a diagram showing a state in which a seat slides during manual driving;

FIG. 7 is a diagram showing a state in which a seat slides during automated driving;

FIG. 8 is a diagram showing an example of a seat device including a mechanism that enables stepwise sliding of a seat;

FIG. 9 is a diagram showing a relationship between openings and protrusions;

FIG. 10 is a diagram showing an example of a seat device in which an urging force is applied to a seat; and

FIG. 11 is a flowchart showing a flow of seat control which is performed by the seat device.

### DETAILED DESCRIPTION OF THE INVENTION

Hereinafter, a vehicle control system, a vehicle control method, and a storage medium according to an embodiment of the invention will be described with reference to the accompanying drawings. In the embodiment, it is assumed that the vehicle control system is applied to a vehicle that enables automated driving. Here, automated driving is automatic control of at least one of acceleration/deceleration and steering of a vehicle such that the vehicle travels or stops.

### Overall Configuration

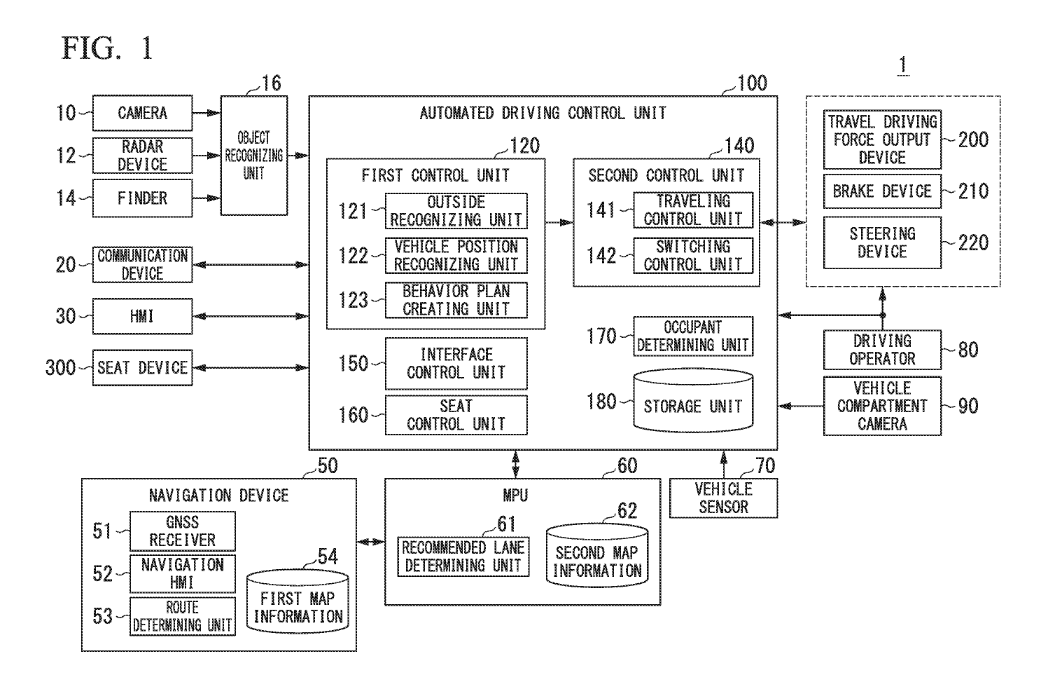

FIG. 1 is a diagram showing a configuration of a vehicle system 1 according to an embodiment. A vehicle (hereinafter referred to as a vehicle M) in which the vehicle system 1 is mounted is, for example, a vehicle with two wheels, three wheels, or four wheels and a drive source thereof is an internal combustion engine such as a diesel engine or a gasoline engine, an electric motor, or a combination thereof. An electric motor operates using electric power which is generated by a power generator connected to the internal combustion engine or electric power which is discharged from a secondary battery or a fuel cell.

The vehicle system 1 includes, for example, a camera 10, a radar device 12, a finder 14, an object recognizing device 16, a communication device 20, a human-machine interface (HMI) 30, a navigation device 50, a micro-processing unit (MPU) 60, a vehicle sensor 70, a driving operator 80, a vehicle compartment camera 90, an automated driving control unit 100, a travel driving force output device 200, a brake device 210, a steering device 220, and a seat device 300. These devices or units are connected to each other via a multiplex communication line such as a controller area network (CAN) communication line, a serial communication line, or a radio communication network. The configuration illustrated in FIG. 1 is only an example and a part of the configuration may be omitted or another configuration may be added thereto.

A “vehicle control system” in the embodiment includes, for example, the automated driving control unit 100 and the seat device 300.

The camera 10 is, for example, a digital camera using a solid-state imaging device such as a charge coupled device (CCD) or a complementary metal oxide semiconductor (CMOS). One or more cameras 10 are attached to arbitrary positions of the vehicle M in which the vehicle system 1 is mounted. In a case that imaging to the front is performed, the camera 10 is attached to an upper part of a front windshield, a rear surface of a room mirror, or the like. In a case that imaging to the rear is performed, the camera 10 is attached to an upper part of a rear windshield, a back door, or the like. In a case that imaging to the side is performed, the camera 10 is attached to a door mirror or the like. The camera 10 images surroundings of the vehicle M, for example, periodically and repeatedly. The camera 10 may be a stereoscopic camera.

The radar device 12 radiates radio waves such as 1 to 10 millimeters radio waves to the surroundings of the vehicle M, detects radio waves (reflected waves) reflected by an object, and detects at least a position (a distance and a direction) of the object. One or more radar devices 12 are attached to arbitrary positions of the vehicle M. The radar device 12 may detect a position and a speed of an object using a frequency modulated continuous wave (FM-CW) method.

The finder 14 is a light detection and ranging or laser imaging detection and ranging device (LIDAR) that measures scattered light in response to applied light and detects a distance to an object. One or more finders 14 are attached to arbitrary positions of the vehicle M.

The object recognizing device 16 performs sensor fusion processing on detection results from some or all of the camera 10, the radar device 12, and the finder 14 and recognizes a position, a type, a speed, and the like of an object. The object recognizing device 16 outputs the recognition result to the automated driving control unit 100.

The communication device 20 communicates with another vehicle near the vehicle M, for example, using a cellular network, a Wi-Fi network, Bluetooth (registered trademark), dedicated short range communication (DSRC), or the like or communicates with various server devices via a radio base station. The communication device 20 communicates with a terminal device which is carried by a person outside the vehicle.

The HMI 30 presents a variety of information to an occupant of the vehicle M and receives an input operation from the occupant. The HMI 30 includes, for example, various display devices, speakers, buzzers, touch panels, various operation switches, and keys.

The navigation device 50 includes, for example, a global navigation satellite system (GNSS) receiver 51, a navigation HMI 52, and a route determining unit 53, and stores first map information 54 in a storage device such as a hard disk drive (HDD) or a flash memory. The GNSS receiver 51 specifies a position of the vehicle M on the basis of signals received from GNSS satellites. The position of the vehicle M may be specified or complemented by an inertial navigation system (INS) using the output of the vehicle sensor 70. The navigation HMI 52 includes a display device, a speaker, a touch panel, and a key. All or a part of the navigation HMI 52 may be shared by the HMI 30. For example, the route determining unit 53 determines a route (for example, which includes information on transit points to a destination) from the position of the vehicle M (or an input arbitrary position) specified by the GNSS receiver 51 to a destination input by an occupant using the navigation HMI 52 with reference to the first map information 54. The first map information 54 is, for example, information in which road shapes are expressed by links indicating roads and nodes connected by the links. The first map information 54 may include a curvature of a road or point of interest (POI) information. The route determined by the route determining unit 53 is output to the MPU 60. The navigation device 50 may perform guidance for a route using the navigation HMI 52 on the basis of the route determined by the route determining unit 53. The navigation device 50 may be realized, for example, by a function of a terminal device such as a smartphone or a tablet terminal which is carried by a user. The navigation device 50 may transmit a current position and a destination to a navigation server via the communication device 20 and may acquire a route which is returned from the navigation server.

The MPU 60 serves as, for example, a recommended lane determining unit 61 and stores second map information 62 in a storage device such as an HDD or a flash memory. The recommended lane determining unit 61 divides a route supplied from the navigation device 50 into a plurality of blocks (for example, every 100 [m] in a vehicle traveling direction) and determines a recommended lane for each block with reference to the second map information 62. The recommended lane determining unit 61 determines in which lane from the leftmost the vehicle will travel. In a case that a branch point or a merging point is present in the route, the recommended lane determining unit 61 determines a recommended lane such that the vehicle M travels in a rational traveling route for going to a branch destination.

The second map information 62 is map information with higher precision than the first map information 54. The second map information 62 includes, for example, information of the center of a lane or information of boundaries of a lane. The second map information 62 may include road information, traffic regulation information, address information (addresses and post numbers), facility information, and phone number information. The road information includes information indicating a type of a road such as an expressway, a toll road, a national road, and a prefectural road or information such as the number of lanes of a road, an area of an emergency parking zone, a width of each lane, a gradient of a road, a position of a road (three-dimensional coordinates including longitude, latitude, and height), curvatures of curves of lanes, positions of merging and branch points of lanes, and signs marked on a road. The second map information 62 may be updated from time to time by accessing another device using the communication device 20.

The vehicle sensor 70 includes a vehicle speed sensor that detects a speed of the vehicle M, an acceleration sensor that detects acceleration, a yaw rate sensor that detects an angular velocity around a vertical axis, and a direction sensor that detects a direction of the vehicle M.

The driving operator 80 includes, for example, an accelerator pedal, a brake pedal, a shift lever, a steering wheel, and other operators. A sensor that detects an amount of operation or performing of an operation is attached to each driving operator 80, and detection results thereof are output to one or both of the automated driving control unit 100 and the travel driving force output device 200, and the brake device 210 and the steering device 220.

The vehicle compartment camera 90 images, for example, one or both of the seat device 300 installed in a vehicle compartment and surroundings of the seat device 300. For example, the vehicle compartment camera 90 periodically repeatedly images the seat device 300. Images captured by the vehicle compartment camera 90 are output to the automated driving control unit 100.

### Automated Driving Control Unit

The automated driving control unit 100 includes, for example, a first control unit 120, a second control unit 140, an interface control unit 150, a seat control unit 160, an occupant determining unit 170, and a storage unit 180. The first control unit 120, the second control unit 140, the interface control unit 150, the seat control unit 160, and the occupant determining unit 170 are embodied by causing a hardware processor such as a central processing unit (CPUT) to execute a program (software). Some or all functional units such as the first control unit 120, the second control unit 140, the interface control unit 150, the seat control unit 160, and the occupant determining unit 170 which will be described below may be embodied by hardware (which includes circuitry) such as a large scale integration (LSI), an application specific integrated circuit (ASIC), or a field-programmable gate array (FPGA) or may be embodied by software and hardware in cooperation. The program may be stored in the storage unit 180 in advance, or may be installed in the storage unit 180 by storing the program in a detachable storage medium such as a DVD or a CD-ROM and attaching the storage medium to a drive device. A part or all of the first control unit 120 and the second control unit 140 is an example of the “automated driving control unit.”

The first control unit 120 includes, for example, an outside recognizing unit 121, a vehicle position recognizing unit 122, and a behavior plan creating unit 123.

The outside recognizing unit 121 recognizes states such as positions, speeds, and accelerations of neighboring vehicles on the basis of information input from the camera 10, the radar device 12, and the finder 14 via the object recognizing device 16. A position of a neighboring vehicle may be expressed by a representative point such as the center of gravity or corners of the neighboring vehicle or may be expressed by an area which is marked by an outline of the neighboring vehicle. A “state” of a neighboring vehicle may include an acceleration, a jerk, or a “behavior condition” (for example, whether lane change is being performed or is intended) of the neighboring vehicle.

The outside recognizing unit 121 may recognize guard rails, telephone poles, parked vehicles, persons such as pedestrians, and other objects, in addition to the neighboring vehicles.

The vehicle position recognizing unit 122 recognizes, for example, a lane (a traveling lane) in which the vehicle M is traveling and a position and a posture of the vehicle M relative to the traveling lane. The vehicle position recognizing unit 122 recognizes the traveling lane, for example, by comparing a pattern of road defining lines around the vehicle M which is recognized from the images captured by the camera 10 with a pattern of road defining lines (for example, arrangements of solid lines and dotted lines) which is acquired from the second map information 62. In this recognition, the position of the vehicle M acquired from the navigation device 50 or processing results from the INS may be considered.

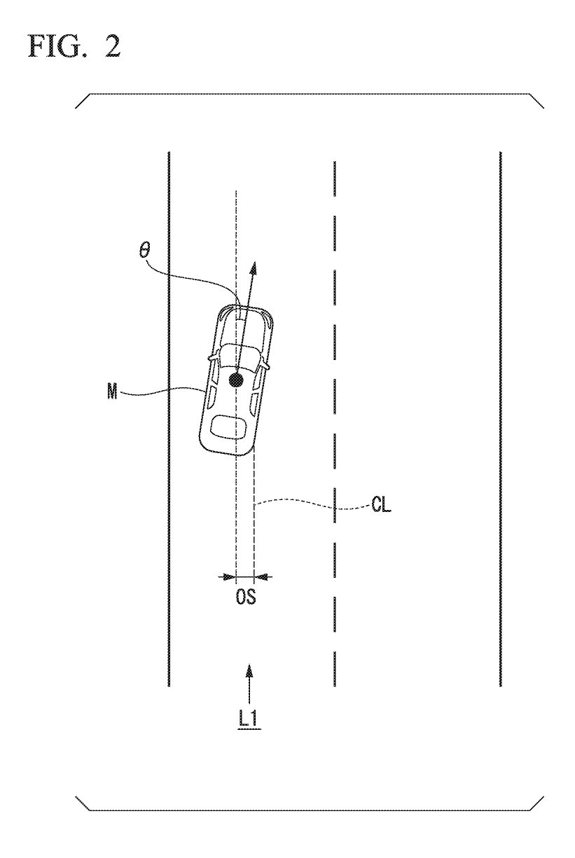

Then, the vehicle position recognizing unit 122 recognizes, for example, a position and a posture of the vehicle M relative to the traveling lane. FIG. 2 is a diagram showing a state in which a position and a posture of the vehicle M relative to a traveling lane 11 are recognized by the vehicle position recognizing unit 122. The vehicle position recognizing unit 122 recognizes, for example, a separation OS of a reference point (for example, the center of gravity) of the vehicle M from a traveling lane center CL and an angle θ formed by a traveling direction of the vehicle M and a line of the traveling lane center CL as a position and a posture of the vehicle M relative to the traveling lane L1. Instead, the vehicle position recognizing unit 122 may recognize a position of the reference point of the vehicle M relative to one edge of the traveling lane L1 or the like as a position of the vehicle M relative to the traveling lane. The relative position of the vehicle M recognized by the vehicle position recognizing unit 122 is supplied to the recommended lane determining unit 61 and the behavior plan creating unit 123.

The behavior plan creating unit 123 creates a behavior plan for causing the vehicle M to execute automated driving to a destination or the like. For example, the behavior plan creating unit 123 determines events which are sequentially performed in automated driving such that the vehicle travels in the recommended lane determined by the recommended lane determining unit 61 and measures for surrounding conditions of the vehicle M can be taken. Examples of the events in the automated driving according to the embodiment include a constant-speed traveling event in which a vehicle travels in the same traveling lane at a constant speed, a lane change event in which the vehicle M changes the traveling lane, a passing event in which the vehicle travels past a preceding vehicle, a following traveling event in which a vehicle follows a preceding vehicle, a merging event in which the vehicle merges at a merging point, a branching event in which the vehicle M travels in a target direction at a branch point of a road, an emergency stop event in which the vehicle M stops suddenly, and a switching event in which automated driving is ended and switched to manual driving. In the course of execution of such events, behavior for avoidance may be planned on the basis of surrounding conditions of the vehicle M (such as presence of a neighboring vehicle or a pedestrian and lane narrowing due to road construction).

The behavior plan creating unit 123 generates a target path in which the vehicle M will travel in the future. A target path includes, for example, a speed element. For example, a target path is generated as a set of target points (path points) at which a vehicle will arrive at a plurality of reference times in the future in a state in which the reference times are set every predetermined sampling time (for example, about several tenths of a [sec]). Accordingly, in a case that a gap between path points is large, it means that a vehicle travels at a high speed in a section between the path points.

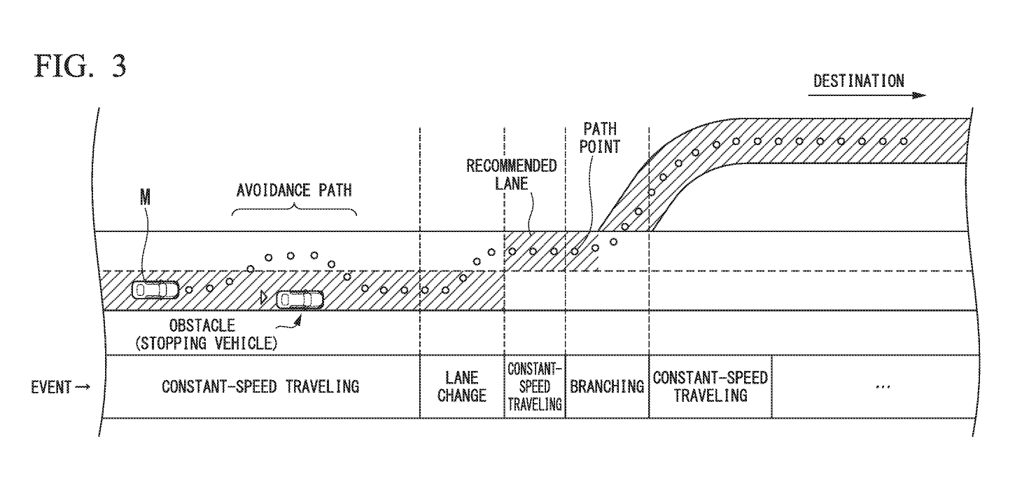

FIG. 3 is a diagram showing a state in which a target path is generated on the basis of a recommended lane. As illustrated in the drawing, the recommended lane is set to be convenient for traveling along a route to a destination. When the vehicle reaches a position prior a predetermined distance (which may be determined depending on a type of an event) to a switching point of the recommended lane, the behavior plan creating unit 123 starts a lane change event, a branching event, a merging event, or the like. In a case that it is necessary to avoid an obstacle during execution of each event, an avoidance path is generated as illustrated in the drawing.

For example, the behavior plan creating unit 123 generates a plurality of candidates for the target path and selects an optimal target path which is suitable for a path to the destination at that time in view of safety and efficiency.

The second control unit 140 includes, for example, a traveling control unit 141 and a switching control unit 142. The traveling control unit 141 controls the travel driving force output device 200, the brake device 210, and the steering device 220 such that the vehicle M passes through the target path generated by the behavior plan creating unit 123 as scheduled.

The switching control unit 142 switches a driving mode of the vehicle M on the basis of the behavior plan which is created by the behavior plan creating unit 123. For example, the switching control unit 142 switches the driving mode from manual driving to automated driving at a scheduled start point of automated driving. The switching control unit 142 switches the driving mode from automated driving to manual driving at a scheduled end point of automated driving.

The switching control unit 142 may switch the driving mode between automated driving and manual driving, for example, on the basis of a switching signal input from an automated driving switch which is included in the HMI 30. The switching control unit 142 may switch the driving mode of the vehicle M from automated driving to manual driving, for example, on the basis of an operation for instructing acceleration, deceleration, or steering for the driving operators 80 such as an accelerator pedal, a brake pedal, and a steering wheel.

During manual driving, input information from the driving operators 80 is output directly to the travel driving force output device 200, the brake device 210, and the steering device 220. The input information from the driving operators 80 may be output to the travel driving force output device 200, the brake device 210, and the steering device 220 via the automated driving control unit 100. Electronic control units (ECUs) of the travel driving force output device 200, the brake device 210, and the steering device 220 perform their operations on the basis of the input information from the driving operators 80 and the like.

The interface control unit 150 causes the HMI 30 to output traveling conditions in automated driving or manual driving of the vehicle M, times of which switching between automated driving and manual driving, notifications associated with a request for causing an occupant to execute manual driving, or the like. The interface control unit 150 may cause the HMI 30 to output information on control details by the seat control unit 160 and information on determination results from the occupant determining unit 170. The interface control unit 150 may output information received via the HMI 30 to the first control unit 120 or the seat control unit 160.

The seat control unit 160 controls the seat device 300 on the basis of the driving mode of the vehicle M as well as controlling the seat device 300 on the basis of information received by an operation unit which is provided in the seat device 300 or information received by the HMI 30. Details of the function of the seat control unit 160 will be described later.

The occupant determining unit 170 determines whether an occupant sits in the seat device 300. The occupant determining unit 170 may determine whether an occupant sits in a seat in the back of the seat device 300. Details of the function of the occupant determining unit 170 will be described later.

The storage unit 180 is constituted, for example, by an HDD, a flash memory, an electrically erasable programmable read only memory (EEPROM), a read only memory (ROM), or a random access memory (RAM). The storage unit 180 stores, for example, a variety of information or programs associated with vehicle control of the embodiment.

The travel driving force output device 200 outputs a travel driving force (a torque) for allowing a vehicle to travel to driving wheels. The travel driving force output device 200 includes, for example, a combination of an internal combustion engine, an electric motor, and a transmission and an ECU that controls them. The ECU controls the above-mentioned configuration on the basis of information input from the traveling control unit 141 or information input from the driving operators 80.

The brake device 210 includes, for example, a brake caliper, a cylinder that transmits a hydraulic pressure to the brake caliper, an electric motor that generates a hydraulic pressure in the cylinder, and a brake ECU. The brake ECU controls the electric motor on the basis of information input from the traveling control unit 141 or information input from the driving operators 80 such that a brake torque based on a braking operation is output to vehicle wheels. The brake device 210 may include a mechanism for transmitting a hydraulic pressure generated by an operation of a brake pedal included in the driving operators 80 to the cylinder via a master cylinder as a backup. The brake device 210 is not limited to the above-mentioned configuration, and may be an electronically controlled hydraulic brake device that controls an actuator on the basis of information input from the traveling control unit 141 or information input from the driving operators 80 such that the hydraulic pressure of the master cylinder is transmitted to the cylinder. The brake device 210 may include a plurality of channels of brake devices in view of safety.

The steering device 220 includes, for example, a steering ECU and an electric motor. The electric motor changes a direction of turning wheels, for example, by applying a force to a rack-and-pinion mechanism. The steering ECU drives the electric motor on the basis of information input from the traveling control unit 141 or information input from the driving operators 80 to change the direction of the turning wheels.

The seat device 300 is a seat in which an occupant of the vehicle M sits and is a seat that can be driven electrically. The seat device 300 includes a driver seat in which an occupant sits to manually drive the vehicle M using the driving operators 80, a passenger seat beside the driver seat, and a rear seat in the back of the driver seat or the passenger seat. In the following description, it is assumed that the “seat device 300” is the driver seat. The seat device 300 operates under the control of the seat control unit 160 which will be described later.

### Configuration and Control of Seat Device 300

A configuration of the seat device 300 according to the embodiment and sliding control based on a control mode of the vehicle M will be described below.

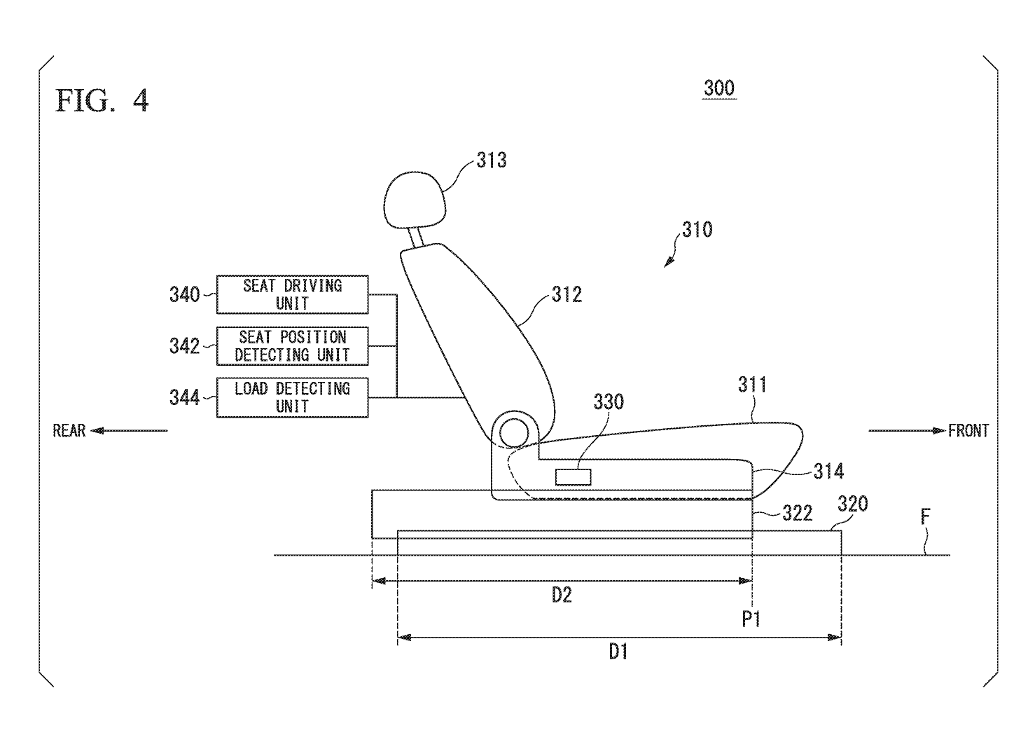

FIG. 4 is a diagram showing the configuration of the seat device 300 according to the embodiment. The seat device 300 includes, for example, a seat (a seat body) 310, a first slide mechanism 320, a second slide mechanism 322, an operation unit 330, a seat driving unit 340, a seat position detecting unit 342, and a load detecting unit 344.

The seat 310 includes, for example, a sitting portion 311, a backrest portion (a seatback) 312, a headrest 313, and a base portion 314. The sitting portion 311 is a portion in which an occupant sits. The backrest portion 312 supports the back of an occupant who has sat on the sitting portion 311. The headrest 313 supports the head of an occupant who has sat on the sitting portion 311. The base portion 314 supports the seat 310. The base portion 314 is provided on the second slide mechanism 322 and is formed to be slidable on the second slide mechanism 322.

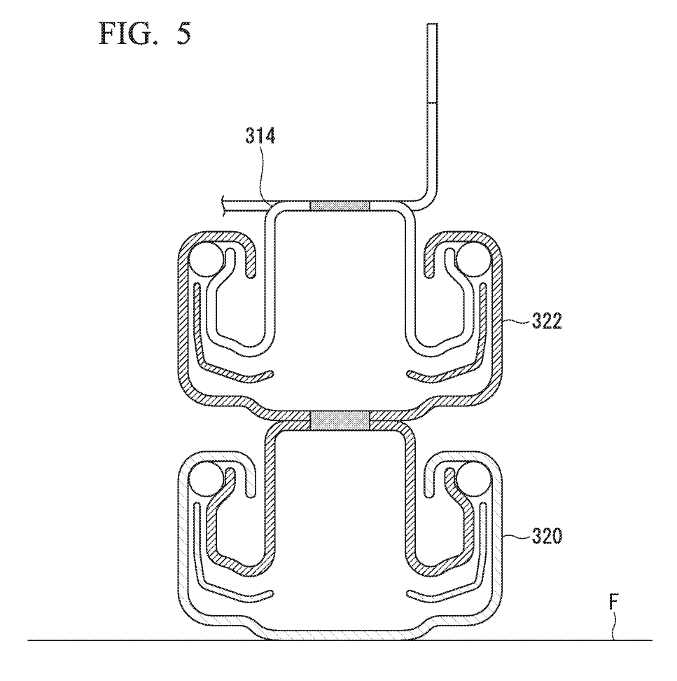

FIG. 5 is a diagram showing a sectional structure of the first slide mechanism 320 and the second slide mechanism 322. The example illustrated in FIG. 5 illustrates a part of a sectional structure when the first slide mechanism 320, the second slide mechanism 322, and the base portion 314 are viewed from the front side of the vehicle M to the rear side. The first slide mechanism 320 is fixed to a floor surface F of the vehicle M and has a concave shape which can be coupled to the second slide mechanism 322. The first slide mechanism 320 is formed to enable the second slide mechanism 322 to slide in the longitudinal direction of the vehicle M using a roller or the like and to hold the second slide mechanism 322 at a predetermined position. The first slide mechanism 320 is, for example, a member having a rod shape or a plate shape which extends by a length D1 in the longitudinal direction of the vehicle M with respect to the floor surface F.

The second slide mechanism 322 is inserted into and coupled to the concave portion of the first slide mechanism 320 and is formed to be slidable in the longitudinal direction of the vehicle M along the first slide mechanism 320 using a roller or the like. The second slide mechanism 322 is coupled to the base portion 314 of the seat 310 which is inserted into the concave portion, and is formed to enable the base portion 314 to slide in the longitudinal direction of the vehicle M using a roller or the like and to hold the base portion 314 at a predetermined position. The second slide mechanism 322 is, for example, a rod shape or a plate shape which extends by a length D2 in the longitudinal direction of the vehicle M along the first slide mechanism 320. For example, the length D2 is smaller than the length D1.

The operation unit 330 can receive, for example, an operation instruction for causing the seat 310 to slide in the longitudinal direction of the vehicle M. When the operation instruction is being received by the operation unit 330 or until a predetermined time elapses after the operation instruction has been received, the seat control unit 160 causes the seat 310 to slide in the instructed direction. The operation unit 330 may be a mechanical switch, an operation button, or an operation lever. The operation unit 330 is provided, for example, in the base portion 314. The operation unit 330 may be provided in the sitting portion 311, the backrest portion 312, the headrest 313, or the like.

The seat driving unit 340 drives a motor which is not illustrated or the like under the control of the seat control unit 160 and changes at least one of the position and the direction of the seat 310. For example, the seat driving unit 340 drives the motor to cause the seat 310 to slide in the longitudinal direction of the vehicle M. The seat driving unit 340 may drive the motor to move the backrest portion 312 such that a reclining angle of the seat 310 increases or decreases.

The seat position detecting unit 342 detects, for example, a slide position of the seat 310. A slide position is, for example, a position of the second slide mechanism 322 in the longitudinal direction of the first slide mechanism 320. A slide position may be a position of the seat 310 in the longitudinal direction of the first slide mechanism 320. The seat position detecting unit 342 may detect the reclining angle of the seat 310. The seat position detecting unit 342 outputs the detection result to the seat control unit 160.

The load detecting unit 344 detects a load on the seat 310. The load detecting unit 344 includes, for example, one or more load sensors in the sitting portion 311 or the backrest portion 312. The load detecting unit 344 outputs the value detected by the load sensor to the occupant determining unit 170.

### Slide Control of Seat 310 During Manual Driving

Slide control of the seat 310 during manual driving will be described below. The seat control unit 160 determines whether the driving mode in execution of the vehicle M is automated driving using the first control unit 120 and the second control unit 140, and enables the second slide mechanism 322 to slide along the first slide mechanism 320 in a case that the driving mode of the vehicle M is manual driving.

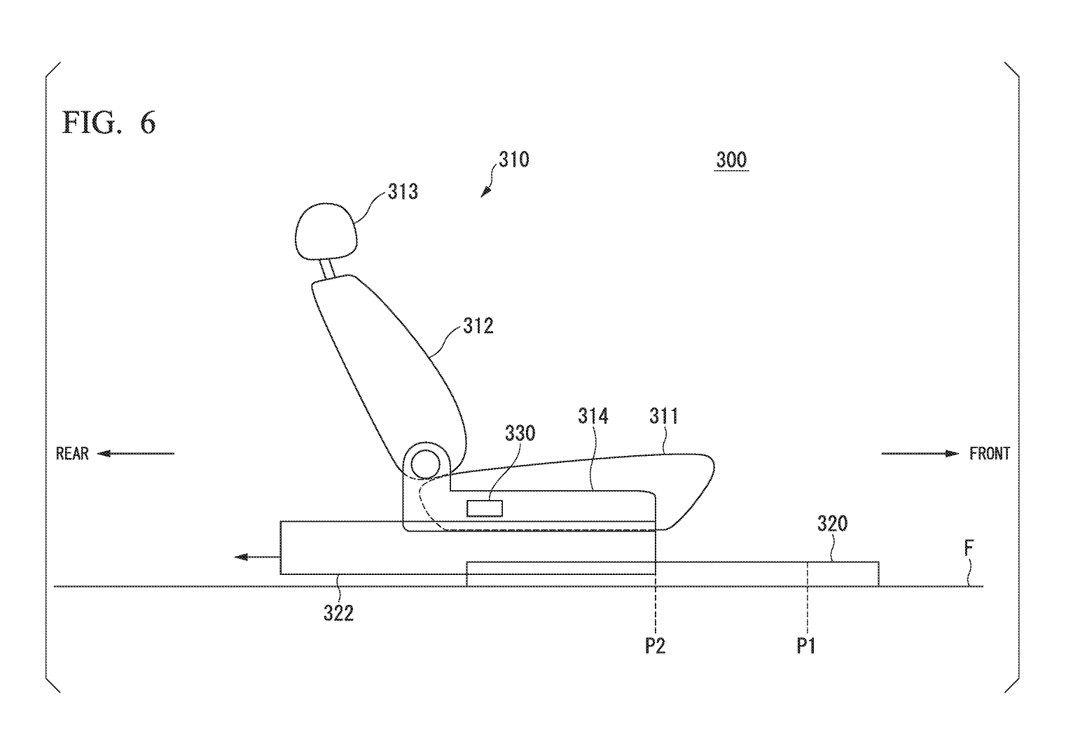

FIG. 6 is a diagram showing an example of slide control of the seat 310 during manual driving. In the example of the seat device 300 illustrated in FIG. 6, the seat driving unit 340, the seat position detecting unit 342, and the load detecting unit 344 are not illustrated. The same is true of other drawings for describing slide control.

It is assumed that an occupant who sits in the seat 310 moves the seat 310 to, for example, a position at which the driving operators 80 can be easily operated during manual driving. In this case, when a slide operation instruction from the occupant is received by the operation unit 330, the seat control unit 160 causes the second slide mechanism 322 to slide on the first slide mechanism 320 using the seat driving unit 340. The seat control unit 160 fixes the seat 310 and the second slide mechanism 322 using a locking mechanism which is not illustrated such that the seat 310 does not slide on the second slide mechanism 322. Accordingly, by allowing the second slide mechanism 322 to slide along the first slide mechanism 320, the seat 310 slides in the longitudinal direction of the vehicle M. In the example illustrated in FIG. 6, the second slide mechanism 322 slides from a position P1 to a position P2.

### Slide Control of Seat 310 During Automated Driving

Slide control of the seat 310 during automated driving will be described below. The seat control unit 160 determines whether the driving mode in execution of the vehicle M is automated driving using the first control unit 120 and the second control unit 140, and enables the seat 310 to slide along the second slide mechanism 322 in a case that the driving mode of the vehicle M is automated driving.

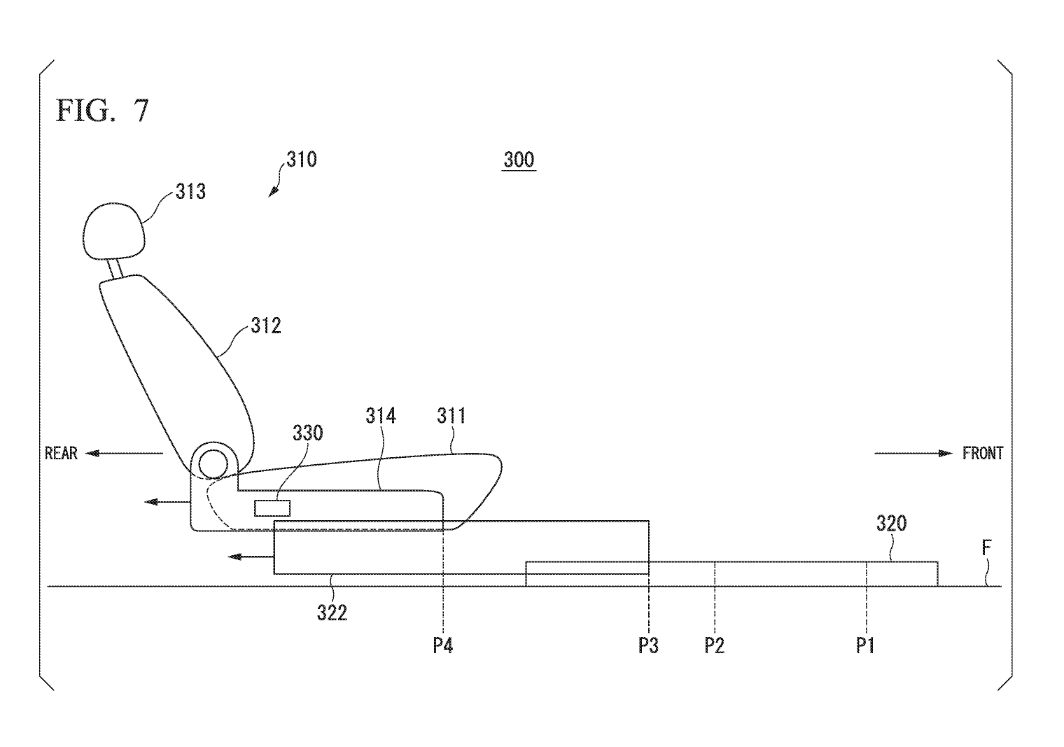

FIG. 7 is a diagram showing an example of slide control of the seat 310 during automated driving. It is assumed that an occupant who sits in the seat 310 moves the seat 310 to the rear side of the vehicle M, for example, in a case that automated driving in which the driving operators 80 does not need to be operated is executed. In this case, when a slide operation instruction from the occupant is received by the operation unit 330, the seat control unit 160 stores position information of the second slide mechanism 322 (for example, position information P2 in FIG. 6) detected by the seat position detecting unit 342 in the storage unit 180. The seat control unit 160 causes the second slide mechanism 322 to slide rearward on the first slide mechanism 320 using the seat driving unit 340 and cause the seat 310 to slide rearward on the second slide mechanism 322. In the example illustrated in FIG. 7, the second slide mechanism 322 slides from the position P2 to the position P3 and the seat 310 slides from the position P3 to the position P4. In this way, during automated driving, the seat control unit 160 can increase a slidable distance in comparison with a slidable distance during manual driving by causing the second slide mechanism 322 to slide along the first slide mechanism 320 and causing the seat 310 to slide along the second slide mechanism 322.

Accordingly, in a situation in which the driving operators 80 do not need to be operated due to automated driving, the slidable range in the vehicle compartment can be broadened. An occupant can easily move to the rear seat or the like, for example, by causing the seat 310 to slide to the rear side of the vehicle M as illustrated in FIG. 7.

In a case that information indicating that the driving mode of the vehicle M is switched from automated driving to manual driving is acquired by the second control unit 140, the seat control unit 160 moves the seat 310 using the seat driving unit 340 such that the seat 310 is returned from the current slide position (P4) to the position (P2) of manual driving stored in the storage unit 180.

The seat control unit 160 may perform control of switching the driving mode from automated driving to the manual driving subject to return of the slide position of the seat 310 to the position of manual driving. In this case, the seat control unit 160 determines whether the slide position of the second slide mechanism 322 has been returned to the position of manual driving and performs control of switching the driving mode from automated driving to manual driving using the second control unit 140 subject to return of the second slide mechanism 322 to the position P2. Accordingly, the second slide mechanism 322 can be easily returned to the position at which the occupant executes manual driving using the position information of the second slide mechanism 322 as a determination condition.

In a case that the driving mode of the vehicle M is automated driving, the occupant determining unit 170 may determine whether another occupant sits in a seat device in the back of the seat device 300. For example, in a case that an average of loads detected by the load detecting unit 344 of the rear seat device is equal to or greater than a threshold value, the occupant determining unit 170 determines that an occupant sits in the rear seat. The occupant determining unit 170 may analyze an image captured by the vehicle compartment camera 90 and may determine that an occupant sits in the rear seat in a case that feature information of a person can be recognized from the image acquired by imaging the rear seat on the basis of the analysis result of the image. The occupant determining unit 170 may detect a locked state of a seat belt which is not illustrated and provided in the rear seat device and may determine that an occupant sits in the rear seat in a case that it is determined that the seat belt constrains an occupant.

In a case that the occupant determining unit 170 determines that an occupant sits in the rear seat of the seat device 300, the seat control unit 160 may perform control such that the seat 310 cannot move on the second slide mechanism 322. Accordingly, it is possible to prevent the seat from coming in contact with an occupant in the back of the seat.

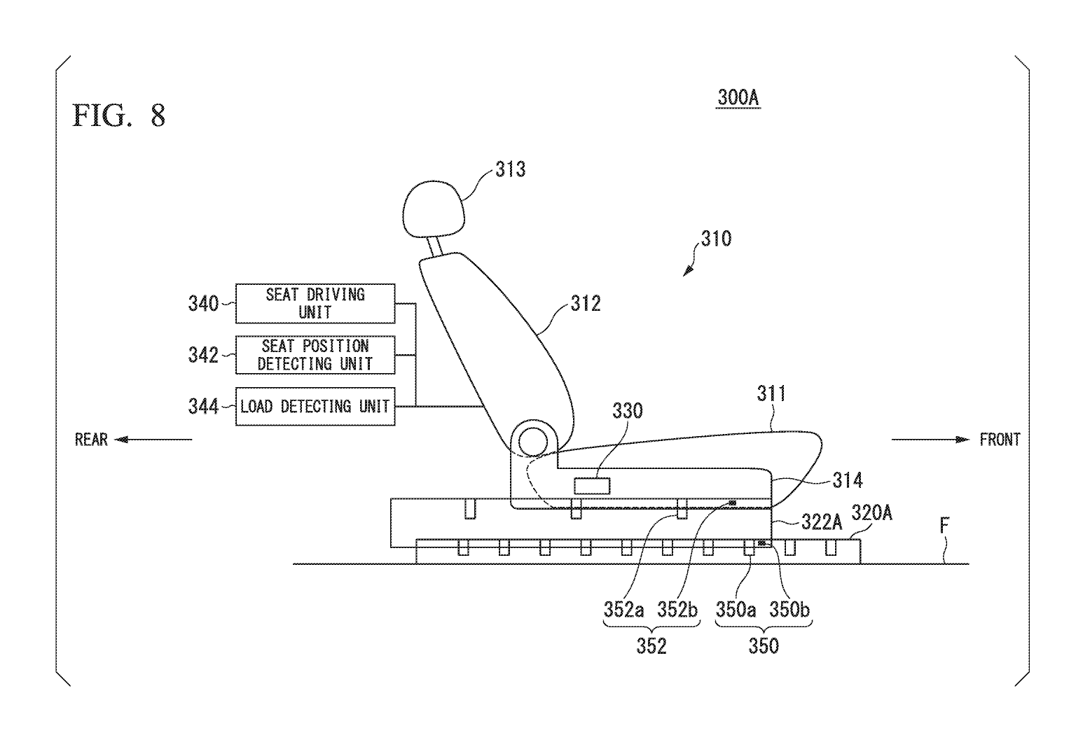

In the embodiment, the seat device may include a mechanism for enabling stepwise slide in a case that the seat 310 slides. FIG. 8 is a diagram showing an example of a seat device 300A including a mechanism for enabling stepwise sliding of the seat 310. The seat device 300A illustrated in FIG. 8 is different from the seat device 300 illustrated in FIG. 4, in that a first slide mechanism 320A and a second slide mechanism 322A are provided instead of the first slide mechanism 320 and the second slide mechanism 322. In the following description, the first slide mechanism 320A and the second slide mechanism 322A will be described with a focus thereon.

The seat device 300A includes, for example, a first restraint portion 350 that restrains sliding of the second slide mechanism 322A on the first slide mechanism 320A and a second restraint portion 352 that restrains sliding of the seat 310 on the second slide mechanism 322A.

The first restraint portion 350 includes, for example, a plurality of openings 350a which are provided in the first slide mechanism 320A and a protrusion 350b which is provided in the second slide mechanism 322A. A plurality of openings 350a are provided at predetermined intervals in the sliding direction of the second slide mechanism 322A. For example, when the seat driving unit 340 causes the second slide mechanism 322A to slide to the rear side of the vehicle M, the protrusion 350b is inserted into the opening 350a. Accordingly, movement of the second slide mechanism 322A is restrained by the first restraint portion 350. When the seat driving unit 340 further applies a rearward force to the second slide mechanism 322A, the protrusion 350b gets out of the opening 350a and thus the rearward sliding movement is restarted.

The second restraint portion 352 includes, for example, a plurality of openings 352a which are provided in the second slide mechanism 322A and a protrusion 352b which is provided in the base portion 314 of the seat 310. A plurality of openings 352a are provided at predetermined intervals in the sliding direction of the seat 310. For example, when the seat driving unit 340 causes the seat 310 to slide to the rear side of the vehicle M during automated driving, the protrusion 352b is inserted into the opening 352a. Accordingly, movement of the seat 310 is restrained by the second restraint portion 352. When the seat driving unit 340 further applies a rearward force to the seat 310, the protrusion 352b gets out of the opening 352a and thus the rearward sliding movement is restarted.

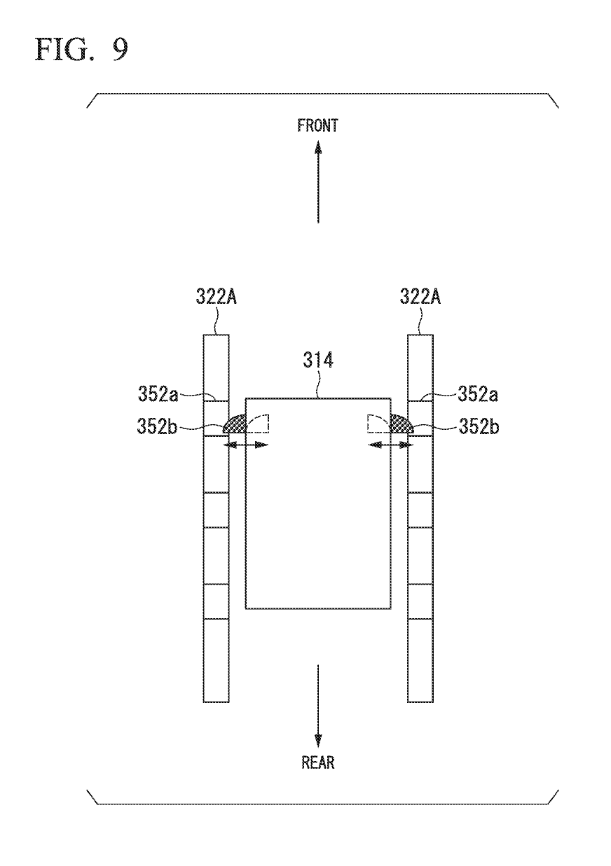

FIG. 9 is a diagram showing a relationship between the openings and the protrusion. In the example illustrated in FIG. 9, the base portion 314, the second slide mechanism 322A which is provided on both lateral sides of the base portion 314, and the openings 352a and the protrusion 352b of the second restraint portion 352 are illustrated. For example, in a case that the protrusion 352b is movable inward in the base portion 314 and does not come in contact with the side surface of the second slide mechanism 322A, a spring mechanism or the like is provided such that the protrusion 352b protrudes outward from the base portion 314.

In the protrusion 352b, a rear surface thereof has a flat plane shape and a front surface thereof has a tapered shape. Accordingly, in a case that the base portion 314 slides rearward, the protrusion 352b is inserted into the opening 352a and is kept locked until a force with a predetermined magnitude or more is applied thereto. On the other hand, in a case that the base portion 314 slides forward, the protrusion 352b is inserted into the opening 352a but is not locked to the tapered surface and can move smoothly. This is the same for the relationship between the openings 350a and the protrusion 350b in the first restraint portion 350. In the first restraint portion 350 and the second restraint portion 352, the positions of the openings and the protrusions may be reversed. A groove or a notch may be provided instead of each opening. The seat device 300 may include a damper mechanism that restrains rearward movement of the seat 310 instead of (or in addition to) the mechanisms of the first restraint portion 350 and the second restraint portion 352.

Accordingly, for example, in a case that the seat 310 slides to the rear side of the vehicle M, the seat stepwise slides while being stepwise restrained by the first restraint portion 350 and the second restraint portion 352 and thus the seat can be easily stopped at a slide position which is desired by an occupant. In a case that the seat 310 is moved forward at the time of switching from automated driving to manual driving, the seat 310 can slide smoothly forward without being restrained by the first restraint portion 350 and the second restraint portion 352 and thus the seat can be rapidly returned to the position of manual driving.

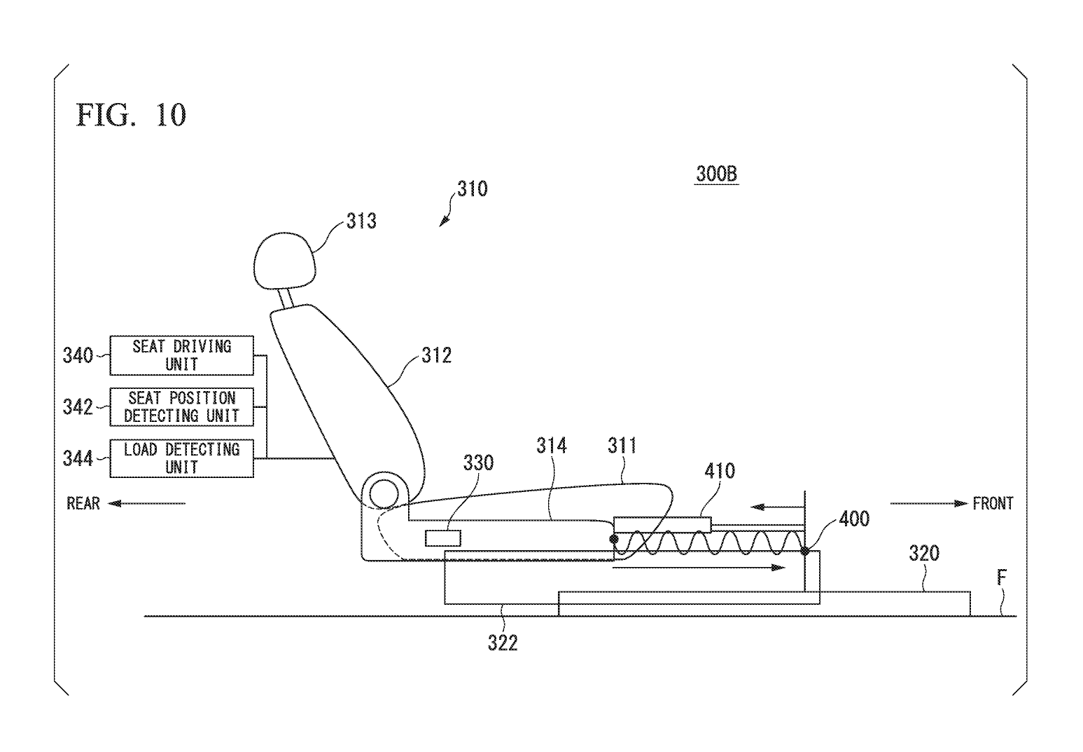

The seat device 300 may include an urging unit that applies an urging force to the seat 310. FIG. 10 is a diagram showing an example of a seat device 300B in which an urging force is applied to the seat 310. In the example illustrated in FIG. 10, a spring mechanism 400 and a damper mechanism 410 are superimposed vertically on the floor surface F, but may be arranged in parallel on the floor surface F of the vehicle M. The spring mechanism 400 and the damper mechanism 410 may be installed lower than the second slide mechanism 322. The spring mechanism 400 is an example of the “urging unit.” The seat device 300B illustrated in FIG. 10 is different from the seat device 300 illustrated in FIG. 4, in that the spring mechanism 400 and the damper mechanism 410 are further provided. In the following description, the spring mechanism 400 and the damper mechanism 410 will be described with a focus thereon.

One end of the spring mechanism 400 is connected to the second slide mechanism 322, and the other end thereof is connected to the base portion 314. The spring mechanism 400 generates an urging force to the front side of the vehicle M in the seat 310, for example, when the spring mechanism 400 draws the seat 310 to the rear side of the vehicle M. The seat device 300B may employ an elastic member of rubber or the like instead of the spring mechanism 400.

One end of the damper mechanism 410 is connected to the second slide mechanism 322 and the other end thereof is connected to the base portion 314. In a case that the seat 310 slides to the front side of the vehicle M by the urging force of the spring mechanism 400, the damper mechanism 410 restrains a moving speed thereof. The restraining force of the damper mechanism 410 is smaller than the urging force of the spring mechanism 400. Accordingly, for example, in a case that the seat 310 is returned to the original position from the rearward moved state during automated driving, the seat 310 can be returned to the original position for a short time by causing the seat 310 to slide with the urging force of the spring mechanism 400 in addition to a driving force of a motor or the like. Accordingly, an occupant can take a posture for executing manual driving with time to spare.

### Process Flow

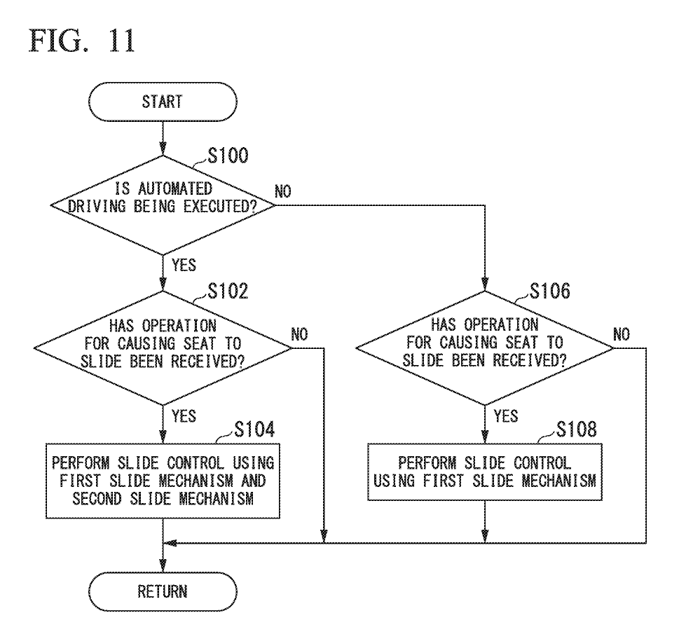

A flow of seat control which is performed by the seat device 300 will be described below. FIG. 11 is a flowchart showing a flow of seat control which is performed by the seat device 300. The seat control illustrated in FIG. 11 is performed at a predetermined time or periodically repeatedly. In the example illustrated in FIG. 11, the seat control unit 160 determines whether the vehicle M is executing automated driving (Step S100). In a case that it is determined that the vehicle M is executing automated driving, the seat control unit 160 determines whether an operation for causing the seat 310 to slide has been received (Step S102). In a case that it is determined that an operation for causing the seat 310 to slide has been received, slide control using the first slide mechanism 320 and the second slide mechanism 322 is enabled (Step S104).

In a case that it is determined in Step S100 that the vehicle M is not executing automated driving, the seat control unit 160 determines whether an operation for causing the seat 310 to slide has been received (Step S106). In a case that it is determined that an operation for causing the seat 310 to slide has been received, slid control using the first slide mechanism 320 is enabled (Step S108). Accordingly, the process flow of the flowchart ends. In a case that it is determined in Step S102 or S106 that an operation for causing the seat 310 to slide has not been received, the process flow of the flowchart also ends.

### Modified Examples

The second slide mechanism 322 in the embodiment may be arranged, for example, on a lateral side of the first slide mechanism 320 instead of on the upper side of the first slide mechanism 320. The second slide mechanism 322 may be a combination of a plurality of slide mechanisms. The spring mechanism 400 and the damper mechanism 410 may be applied to the second slide mechanism 322 that slides on the first slide mechanism 320.

According to the above-mentioned embodiment, it is possible to realize movement of a seat in a longitudinal direction of a vehicle depending on control modes of the vehicle.

The embodiment can also be described as follows.

A vehicle control system includes a storage unit and a hardware processor that executes a program stored in the storage unit, and the hardware processor executes the program: to execute automated driving of automatically controlling at least one of acceleration/deceleration and steering of a vehicle; to enable movement of a seat in which an occupant sits using a first slide mechanism that enables movement of the seat in a longitudinal direction of the vehicle and a second slide mechanism that enables movement of the seat in the longitudinal direction of the vehicle and that is movable in the longitudinal direction of the vehicle along the first slide mechanism in a case that the automated driving is being executed; and to enable movement of the seat using the first slide mechanism in a case that the automated driving is not being executed.

While embodiments of the invention have been described above, the invention is not limited to the embodiments and can be subjected to various modifications and substitutions without departing from the gist of the invention.

What is claimed is:

1. A vehicle control system comprising:
a seat in which an occupant sits;
a first slide mechanism configured to enable movement of the seat in a longitudinal direction of a vehicle;
a second slide mechanism configured to enable movement of the seat in the longitudinal direction of the vehicle and to be movable in the longitudinal direction of the vehicle along the first slide mechanism;
an automated driving control unit configured to execute automated driving of automatically controlling at least one of acceleration/deceleration and steering of the vehicle; and
a seat control unit configured to enable movement of the seat using the first slide mechanism and the second slide mechanism in a case that the automated driving is being executed by the automated driving control unit and to enable movement of the seat using the first slide mechanism in a case that the automated driving is not being executed.

2. The vehicle control system according to claim 1, wherein the automated driving control unit switches the automated driving to manual driving subject to return of the second slide mechanism to a slide position before the automated driving is executed.

3. The vehicle control system according to claim 1, wherein the second slide mechanism includes a mechanism that moves the seat stepwise in a case that the seat is moved rearward.

4. The vehicle control system according to claim 3, wherein the second slide mechanism further includes a restraint unit that restrains movement of the seat at predetermined distances in a case that the seat is moved rearward.

5. The vehicle control system according to claim 1, wherein the second slide mechanism includes an urging unit that applies a forward urging force to the seat.

6. The vehicle control system according to claim 1, further comprising an occupant determining unit configured to determine whether an occupant sits in a rear seat of the seat,
wherein the seat control unit prohibits movement of the seat using the second slide mechanism in a case that the occupant determining unit determines that an occupant sits in the rear seat.

7. A vehicle control method comprising causing an on-board computer to:
execute automated driving of automatically controlling at least one of acceleration/deceleration and steering of a vehicle;
enable movement of a seat in which an occupant sits using a first slide mechanism that enables movement of the seat in a longitudinal direction of the vehicle and a second slide mechanism that enables movement of the seat in the longitudinal direction of the vehicle and that is movable in the longitudinal direction of the vehicle along the first slide mechanism in a case that the automated driving is being executed; and
enable movement of the seat using the first slide mechanism in a case that the automated driving is not being executed.

8. A non-transitory computer-readable storage medium having a vehicle control program stored therein, the vehicle control program causing an on-board computer to:
execute automated driving of automatically controlling at least one of acceleration/deceleration and steering of a vehicle;
enable movement of a seat in which an occupant sits using a first slide mechanism that enables movement of the seat in a longitudinal direction of the vehicle and a second slide mechanism that enables movement of the seat in the longitudinal direction of the vehicle and that is movable in the longitudinal direction of the vehicle along the first slide mechanism in a case that the automated driving is being executed; and
enable movement of the seat using the first slide mechanism in a case that the automated driving is not being executed.
